(19) United States
(12) Patent Application Publication
(10) Pub. No.: US 2011/0151895 A1
(43) Pub. Date: Jun. 23, 2011

(54) MOBILE MONITORING DEVICE AND MONITORING SYSTEM FOR ELECTRONIC EQUIPMENT

(75) Inventor: Todd Kleperis, Shenzhen (CN)

(73) Assignee: I-CONTAIN LIMITED, Central (HK)

(21) Appl. No.: 12/825,630

(22) Filed: Jun. 29, 2010

(30) Foreign Application Priority Data
Dec. 21, 2009 (CN) 200920317940.8

(51) Int. Cl. H04W 24/00; H04R 3/00

(52) U.S. Cl. 455/456.6; 381/122

(57) ABSTRACT

A mobile monitoring device with a global positioning function that can interfere with monitored electronic equipment and a monitoring module that can carry out two-way communication with a control center. The monitoring module is connected to a power module and electrically linked to a voice device in two-way communication. The monitoring module is electrically connected to switch control wiring and sends switching order to it, so as to transfer between power control wiring and signal control wiring. The power control wiring and the signal control wiring of this mobile monitoring device are electrically linked to the monitored electronic equipment. In this way, it can conduct power control or signal control on the monitored electronic equipment.

### CROSS REFERENCE TO RELATED APPLICATIONS

This application claims priority benefit under the Paris Convention of Chinese Application No. 200920317940.8, filed Dec. 21, 2009, the contents of which are herein incorporated by reference.

### FIELD OF INVENTION

This present invention relates to a mobile tracker; more specifically, a mobile monitoring device that can distantly track electronic equipment, and a monitoring system adopting this monitoring device.

### BACKGROUND

Electronic equipment (such as automatic teller machines (ATMs), medical equipment, television sets for rent and air conditioners) were usually monitored by labor intensive means. If the electronic equipment was lost or stolen, the owner of the lost property often turned to collection agencies, asset recovery firms, or various other organizations. However, this form of monitoring is high in employee cost and asset searching fees. A global positioning system (GPS) tracker can be installed on the monitored electronic equipment for positioning, but it cannot interfere with the equipment. If the GPS tracker is removed or out of power, there is no way for the owner to recover it.

### SUMMARY

The present invention includes a mobile monitoring device and a monitoring system with such a device that can interfere in and switch on/off the monitored electronic equipment. The present invention is includes a mobile GPS monitoring device, which comprises a monitoring module that carries out two-way communication with a control center. The monitoring module is electrically connected to a power module and also electrically connected to a switch control wiring. The monitoring module sends a line-switching order (or signal), to transfer between a power control wiring and a signal control wiring. The power control wiring and the signal control wiring are each electrically connected to the monitored electronic equipment, so as to control the power or signal, respectively, of the monitored electronic equipment. The monitoring module is also electrically connected to a voice device in two-way communication.

In an embodiment, the monitoring module is a GSM module.

In another embodiment, the power module includes a power processing module, a built-in standby power source and an automatic power switch. The power processing module is connected to an external power source. The power processing module and the built-in standby power are each separately connected to the automatic power switch, and electrically connected to the monitoring module through the automatic power switch.

In an additional embodiment, the voice device is a microphone.

In a further embodiment, the control center comprises one or more mobile phones and/or PCs.

In another embodiment, the mobile monitoring device is equipped with a SIM card so as to provide communication between monitoring module to the control center.

In an additional embodiment, the invention also includes a monitoring system to monitor the mobile monitoring device. The monitoring system includes a control center and monitored electronic equipment. The monitored electronic equipment is installed with a mobile monitoring device whose power control wiring and signal control wiring are electrically connected to the circuit of the monitored electronic equipment separately. The control center and the mobile monitoring device mutually communicate through the communication satellite or mobile phone/telephone signal transceiver tower.

In another embodiment, the monitored electronic equipment is a solar panel, a wind motor, an air conditioner, a portal electronic device, a medical device, a television set or an ATM machine.

Because the mobile monitoring equipment of this invention has the global positioning device (such as GPS), the monitoring module will send a signal to the control center if the monitored electronic device is out of a predetermined area. Meanwhile, this mobile monitoring device can interfere in the monitored electronic equipment, such as cutting off the power or signal of the monitored electronic device. The monitoring module can send a line switching signal to the switch control wiring so as to switch between the power control wiring and the signal control wiring to control the power and signal of the monitored electronic equipment.

For example, the mobile monitoring device of this invention can be installed in a television set for rent. If the renter does not pay the rent in time, the rental company can send a signal to the monitoring module (such as GSM module) distantly through the control center (e.g. mobile phone or computer) to cut off the power or interrupt the signal of the television set via the power control wiring or signal control wiring. As a result, the renter cannot use this television set any more. After receiving the rent, the rental company can distantly send the signal to resume the power or signal.

The mobile monitoring device can also be detected when it is being removed and/or powered off. If someone tries to remove this monitoring device or cut off its power, or the monitored electronic equipment is shocked terribly, the monitoring module will send alarming signal to the control center.

### BRIEF DESCRIPTION OF THE DRAWINGS

For a fuller understanding of the invention, reference should be made to the following detailed description, taken in connection with the accompanying drawings, in which:

FIG. 1 is a diagram of a monitoring device and its connections to the mobile monitoring system and the control center in accordance with an embodiment of the present invention.

FIG. 2 is a diagram of a mobile monitoring system in accordance with an embodiment of the present invention.

FIG. 3 is a diagram of another mobile monitoring system in accordance with an embodiment of the present invention.

FIG. 4 is a diagram of yet another mobile monitoring system in accordance with an embodiment of the present invention.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

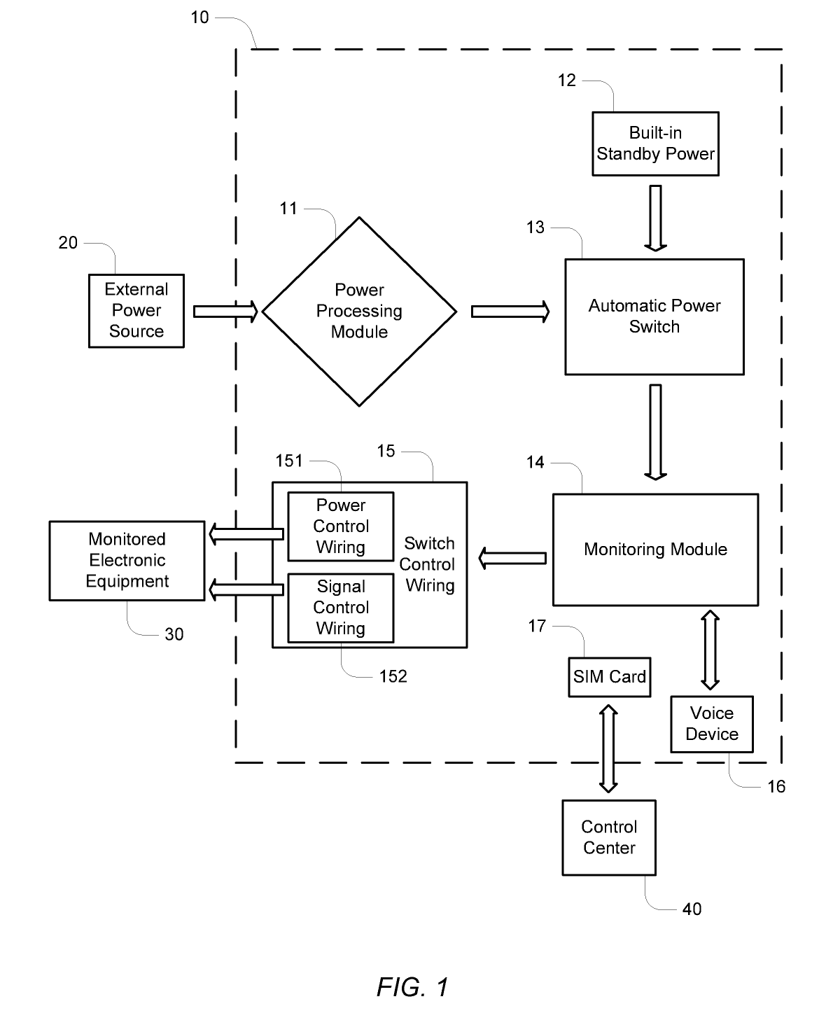

Referring to FIG. 1, mobile monitoring device 10 is provided, which not only has a global positioning function (such as GPS), but can also interfere in the monitored electronic equipment. Mobile monitoring device 10, includes power processing module 11, built-in standby power 12, power automatic transfer switch 13, monitoring module (e.g. Global System for Mobile Communication (GSM) module) 14, switch control wiring 15, power control wiring 151, signal control wiring 152, and voice device 16.

The power module of mobile monitoring device 10 is composed of power processing module 11, built-in standby power 12, and automatic power switch 13. Power processing module 11 and built-in standby power 12 are separately electrically connected to automatic power switch 13 and electrically linked to monitoring module 14 through automatic power switch 13. When mobile monitoring device 10 is connected to external power source 20, power processing module 11 will manage external power source 20 so as to meet the requirements of mobile monitoring device 10. For example, power processing module 11 may reduce the voltage to the appropriate level. If external power source 20 is switched off, automatic power switch 13 will be automatically transferred to built-in standby power 12 in order to keep mobile monitoring device 10 operating. The power module can use the existing technical plan.

Monitoring module 14 adopts the widely used GSM module (CDMS may also be used), which can communicate with control center 40 in two-way fashion. Control center 40 may be one or more mobile phones and/or PCs. Mobile monitoring device 10 is installed with SIM card 17 and connected to monitoring module 14 so that it can realize communication with control center 40. Said monitoring module 14 is also electrically connected to voice device 16, which may be a microphone. Monitoring module 14 can collect sound from voice device 16 and give orders to it to send out sound. Monitoring module 14 is linked with switch control wiring 15 and sends orders to it to switch the circuit. According to the order, the shift is between power control wiring 151 and signal control wiring 152, which are each separately electrically connected to monitored electronic equipment 30 and used to control the power or signal, respectively, of monitored electronic equipment 30.

In addition, mobile monitoring device 10 also includes a circuit that can detect its removal and/or power failure status (not shown in the figure). If an attempt is made to remove mobile monitoring device 10 or cut off its power, monitoring module 14 will send an alarm message to control center 40. In addition, mobile monitoring device 10 may be equipped with a vibration detecting device (not shown in the figure). If monitored electronic equipment 30 is shocked, monitoring module 14 will send an alarm message to control center 40.

Mobile monitoring device 10 further includes a built-in password and an information checking system. The supervisor can set the password through control center 40 (e.g. a mobile phone or computer). Mobile monitoring device 10 will automatically confirm the password preset by the supervisor.

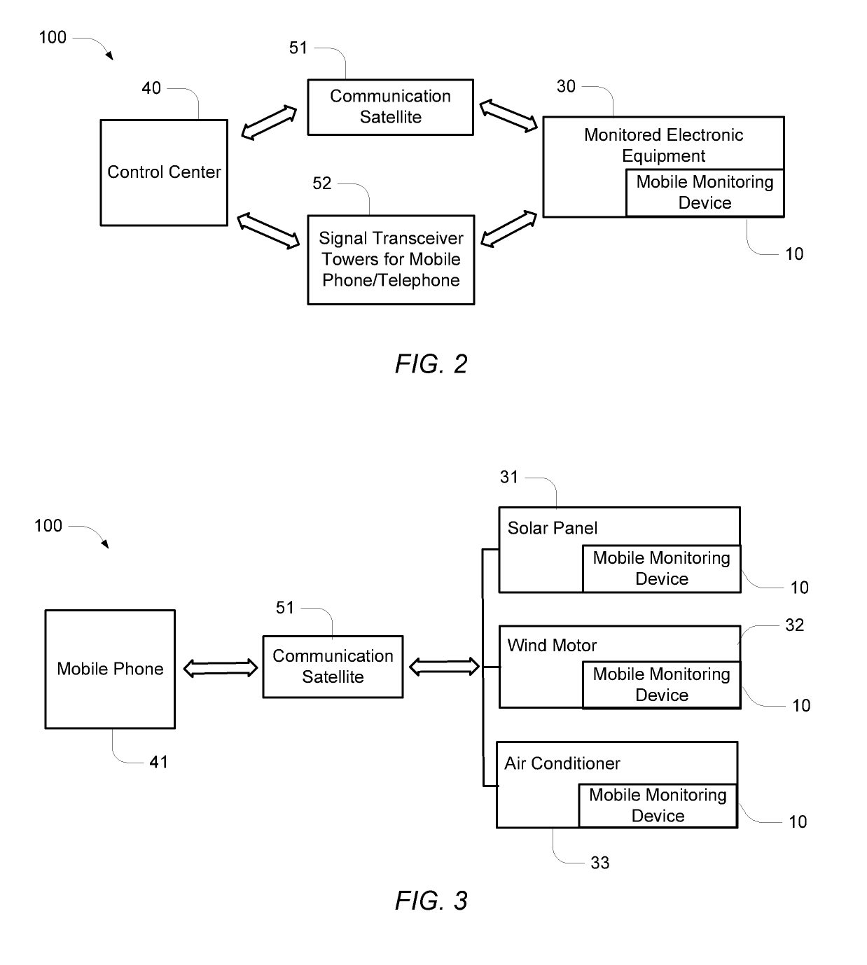

With reference to FIG. 2, mobile monitoring device 10 is included in the monitoring system and can be installed inside monitored electronic equipment 30. The power control wiring (FIG. 1, 151) and the signal control wiring (FIG. 1, 152) of mobile monitoring device 10 are separately electrically connected to the circuit of monitored electronic equipment 30. Control center 40 conducts two-way signal transmission with mobile monitoring device 10 through communication satellite 51 or mobile phone/telephone signal transceiver tower 52. This two-way communication allows mobile monitoring device (FIG. 1, 10) to send alerts to control center 40 and allows control center 50 to locate and interfere in monitored electronic equipment 30.

In the interfering process, referring back to FIG. 1, monitoring module (e.g. GSM Module) 14 detects the mobile phone network. Then, control center 40 sends out a data order through SIM card 17 to instruct mobile monitoring 14 to process the order. Then, the order is sent to switch control wiring 15 through power control wiring 151 or signal control wiring 152, to control the operation or power status of monitored electronic equipment 30. The status of monitored electronic equipment 30 is sent to the control center 40 through monitoring module 14. Mobile monitoring device 10 takes power from external power source 20 or the built-in standby power. If the order is not sent or external power source 20 is cut off or not enough, mobile monitoring device 10 will be automatically switched to the standby battery mode. At this time, the supervisor can listen to the position information of monitored electronic equipment 30 through voice device 16 (e.g. the microphone).

Referring to FIG. 2, control center 40 sends out a signal order to mobile monitoring device 10 through communication satellite 51 or mobile phone/telephone signal transceiver tower 52, so that monitored electronic equipment 30 can be tracked and located. If monitored electronic equipment 30 is out of a preset area, it can send such information to control center 40.

### EXAMPLE 1

### Air Conditioning Equipment

Referring to FIG. 3, mobile phone 41 (of control center 40) sends out a signal order to mobile monitoring device 10 through communication satellite 51, so as to locate solar panel 31 to conduct interference or locate wind motor 32 and conduct interference. In this way, it can control the battery discharging and power on/off of air conditioning equipment 33.

### EXAMPLE 2

### Medical Equipment

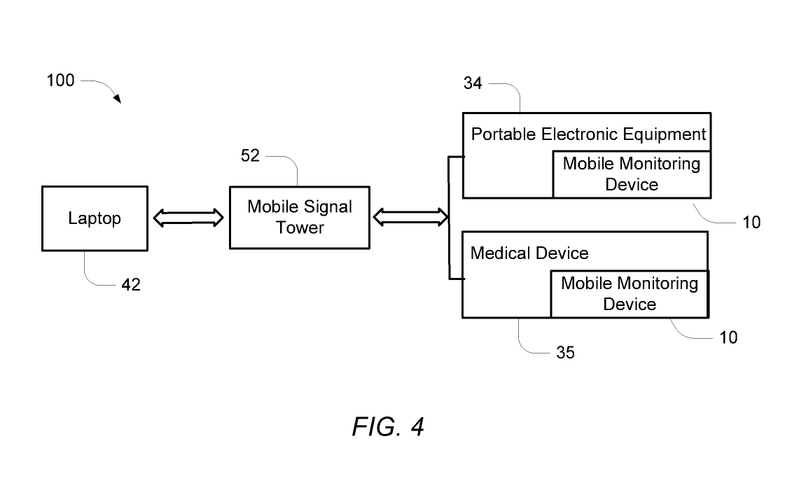

Referring to FIG. 4, laptop 42 (of control center 40) sends out a signal order to mobile monitoring device 10 through mobile signal tower 52, in order to locate and track monitored portable electronic equipment 34 or medical equipment 35 and conduct interference. It has the function of distant tracking, positioning, and interference.

In addition, the mobile monitored device 10 of this invention can also be installed inside electronic equipment, such as a television set or a bank ATM machine, for monitoring and interference.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

1. A mobile monitoring device, comprising:
a monitoring module to carry out two-way communication with a control center;
a global positioning device connected to the monitoring module;
a power module connected to the monitoring module:
a switch control wiring connected to the monitoring module:
a power control wiring, connected to the switch control wiring, to connect to a monitored electronic equipment; and
a signal control wiring, connected to the switch control wiring, to connect to the monitored electronic equipment.

2. The mobile monitoring device of claim 1, wherein the monitoring module is a GSM module.

3. The mobile monitoring device of claim 1, wherein the power module comprises:
a power processing module to connect to an external power source:
a built-in standby power source: and
an automatic power switch connected to the power processing module, the built-in standby power source, and the monitoring module.

4. The mobile monitoring device of claim 2, wherein the voice device is a microphone.

5. The mobile monitoring device of claim 1, wherein the control center comprises one or more devices, the devices including mobile phones and computers.

6. The mobile monitoring device of claim 1, further comprising:
a SIM card to provide communication between the monitoring module and the control center.

7. The mobile monitoring system of claim 1, wherein the monitoring module is in two-way communication with the control center via a communication satellite.

8. The mobile monitoring device of claim 1, wherein the monitored electronic equipment is chosen from the group consisting of a solar panel, a wind motor, air conditioning equipment, portable electronic equipment, medical equipment, a television set, and an ATM machine.

9. (canceled)

10. The mobile monitoring device of claim 1, further comprising:
a voice device connected to the monitoring module.

11. The mobile monitoring device of claim 1, wherein the monitoring module is in two-way communication with the control center via a phone signal transceiver tower.
